(19) United States
(12) Patent Application Publication
(10) Pub. No.: US 2010/0131287 A1
(43) Pub. Date: May 27, 2010

(54) RESCUE AND TRAVEL ASSISTANCE COVERAGE PROGRAM FOR HOTEL GUEST

(76) Inventor: JOSE TERRY, North Miami, FL (US)

Correspondence Address: John Alumit, 16830 Ventura Blvd. Suite 360, Encino, CA, 91436, US

(21) Appl. No.: 12/622,048

(22) Filed: Nov. 19, 2009

Related U.S. Application Data
(60) Provisional application No. 61/117,891, filed on Nov. 25, 2008.

(51) Int. Cl. G06Q 40/00; G06Q 50/00; G06Q 10/00

(52) U.S. Cl. 705/2; 705/4

(57) ABSTRACT

A method for providing emergency travel assistance services automatically to travelers/hotel guests on both a nationwide and worldwide basis upon checking into a participating hotel or resort. The hotels or resorts, in conjunction with a rescue entity, offer a rescue/travel assistance coverage program as a part of its lodging services to guests. The hotels or resorts incorporate the costs of the rescue/travel assistance coverage program into the cost of booking a room. A hotel plaque is displayed in the hotel identifying a rescue entity and services provided. A data layout format filled with the information of the guests registered at the hotels or resorts and the enrollment list of all travelers/hotel guests entitled to the coverage program is submitted to the rescue entity's FTP environment. The data is finally uploaded into a dedicated Sequel server which determines all the travelers/hotel guests enrolled in the event of a claim.

### CROSS-REFERENCE TO RELATED APPLICATION

This application claims the benefit of provisional application No. 61/117,891 filed on Nov. 25, 2008.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### Biodegradable

### BACKGROUND

The present invention relates in general to travel assistance services offerings, and more particularly, to a method for providing at least one emergency service automatically to all travelers/hotel guests on both a nationwide and worldwide basis upon checking into any participating hotels or resorts.

Traveling from one place to another can be a very exciting adventure but a traveler can also encounter a wide variety of difficulties or situations while registered as a hotel guest for which traveler assistance is needed. Many of these difficulties or situations are unpredictable to the travelers. For example, travelers could unknowingly end up in an unsafe environment while away from their hotel, or be involved in an accident in unfamiliar locations. Different languages, laws, currency conversions, inadequate medical facilities, inexperienced international claims administration, and time difference may cause additional complications for the guest traveler in the event of an unexpected emergency.

Similarly, medical problems and concerns about the extreme costs of emergency medical evacuations can also occur while traveling. Travelers may be forced to locate a doctor, nurse, hospital or clinic in an unfamiliar location. Many travelers are concerned about losing their luggage or travel documents. As a result, guest travelers require assistance in obtaining information and travel assistance in such exigent circumstances to ensure a safer and more enjoyable hotel stay while away from home.

There are a variety of known methods for providing travel-related service coverage for travelers. A method and system for providing travel services has been proposed in U.S. Pat. No. 7,389,244 issued to Kaplan. The method and system include a database of travel information from which information can be selectively obtained based on the traveler's circumstances. This method and system also includes counseling services and an emergency kit containing food, water and other supplies. A mobile communications device is also provided to enable the traveler to transmit his or her location in order to initiate the dispatch of a rescue services to the traveler or transport the traveler to a location of greater safety, if required.

U.S. Pat. No. 5,732,398 issued to Tagawa, discloses a self-service system of selling travel-related services or products through an interactive travel service system that functions much like a travel agent. A user is first queried as to travel knowledge, such as whether the user is a first-time visitor or is otherwise familiar with the travel destination, preference for airlines, lodgings, car rental companies, price range and lifestyle etc. Based on the travel knowledge and attributes inputted electronically by the user, one or more recommendations, or a whole listing will be presented for selection by the user. The user is asked to input the relevant dates into the inventory database so that only available choices will be presented. The system is particularly advantageous as a self-service method of selling travel-related services or products such as local tour attractions, local bookings, car rental bookings, local or intrastate tour packages, airline tickets, out-of-state tour packages, cruises, optional tours or cruises, and other shopping options.

U.S. Pat. Application No. 20080021748 entitled to Bay discloses a system and method for presenting travel-related products and services to the traveler. A global distribution service maintains records associated with individual travelers. Each traveler's record contains information corresponding to a destination for that traveler along with the corresponding travel dates. The traveler receives the information contained in the record from the global distribution service. Based on that information, the invention automatically provides to the traveler travel-related products and services from a number of providers corresponding to the destination and dates.

All of the travel-related services and products discussed above involve a highly labor-intensive process. In some methods, the travel-related services and products are delivered to the traveler with the help of mobile communication services. Though this method is a convenient and simple way to provide service to travelers, it is often ineffective because such a coverage program lacks accessibility to individuals directly and do not go far enough in assisting the traveler. For example, the above mentioned system and method provides “information” but does not assist the traveler in making a selection between services. The information does not sufficiently describe the advantages/disadvantages of one service over the other. While this may be useful for some experienced travelers, it is not a practical system for selling leisure travel coverage to less-experienced travelers.

A major problem within the conventional travel assistance/insurance industry is the high cost of the distribution coverage system. A large portion of this cost is attributable to the sales process. It is very labor-intensive and time-consuming to qualify the customer, to present the availability of coverage information, to assist the customer in making a decision, closing the sale, accepting payment, delivering tickets, and documenting the sale. This function is presently being performed by travel agents, reservations agents employed by travel suppliers, various on-line providers, and agents at travel desks at tourist destination areas. Even if the customer has gone through the brochures regarding the services available, the problem associated with conventional distribution systems is that the customer is often confused about the extent of the selected coverages and then has to pay the amount as soon as he/she joins in the policy.

Therefore, an object of the present invention is to provide a method for providing travel assistance services automatically to all travelers/hotel guests on both a nationwide and worldwide basis upon checking into any participating hotels or resorts. Another object of the invention is to provide services to the travelers/hotel guests without separately charging them insurance premiums as is the case with traditional travel insurance, or any extra fees because the hotels that offer the rescue/travel assistance coverage program to their guests as a part of their lodging services, will include the costs of coverage into the cost of booking a room. Other object of the present invention will become better understood with reference to appended Summary, Description and Claims.

### SUMMARY

The present invention is a method for providing at least one emergency service automatically to travelers/hotel guests on both a nationwide and worldwide basis upon checking into at least one participating hotel or resort. The at least one emergency service includes emergency transportation services, medical evacuation and repatriation assistance services, legal assistance, emergency payment assistance, emergency message assistance, emergency cash assistance, vehicle return services, etc. The at least one participating hotel or resort will extend a rescue/travel assistance coverage program as a benefit to their guests and as part of their lodging services to the travelers/hotel guests. The at least one participating hotel or resort sign an agreement with a business entity having a rescue program (“rescue entity”). The rescue entity and the description of the at least one emergency service are listed on a plaque which may be exhibited in a reception area of the at least one participating hotel or resort. The at least one participating hotel or resort provide the rescue/travel assistance coverage program without separately charging the travelers/hotel guests any extra fees. The at least one participating hotel or resort incorporate the costs of the rescue/travel assistance coverage program into the cost of booking a room. Training is provided to hotel administration personnel for explaining the services, the benefits available, the claims process and implementation requirements.

The at least one participating hotel or resort is provided with at least one data layout format which relates to data to be sent to the rescue entity's file transfer protocol (FTP) environment on a daily basis. The at least one data layout format is filled with information about the guests registered at the at least one participating hotel or resort and the enrollment list of all travelers/hotel guests entitled to the rescue/travel assistance coverage program. The at least one data layout format with the recorded information is submitted to the rescue entity's FTP environment, then the data is uploaded into a dedicated Sequel server which identifies all the travelers/hotel guests covered by the rescue/travel assistance coverage program in the event of a claim. The at least one emergency service is provided to the travelers/hotel guests enrolled in the event of a claim and their eligible dependents under a travel assistance program.

### BRIEF DESCRIPTION OF THE FIGURES

FIG. 1 is a diagrammatic representation of a method according to the present invention for providing a rescue/travel assistance coverage program with at least one emergency service to the travelers/hotel guests upon checking into at least one of participating hotel or resort.

FIG. 2 is a flow chart illustrating a procedure for providing the rescue/travel assistance coverage program to the travelers/hotel guests.

FIG. 3 is a flow chart illustrating a procedure for collecting and transmitting the data by computer and the internet.

### REFERENCE NUMERALS

10 . . . Diagrammatic representation of a method according to the present invention
12 . . . At least one emergency service
14 . . . Travelers/Hotel Guests
16 . . . At least one participating hotel or resort
18 . . . Rescue/travel assistance coverage program
20 . . . Service 1
22 . . . Service 2
24 . . . Service 3
26 . . . Service n
28 . . . Rescue entity's FTP environment
30 . . . At least one data layout format
40 . . . Flow chart of procedure for providing the resort/travel assistance rescue coverage program to the travelers/hotel guests
44 . . . Entering into an agreement
44 . . . Offering a rescue/travel assistance coverage program
46 . . . Providing training to hotel administration personnel
48 . . . Incorporating cost of the rescue/travel assistance coverage program into rates of the at least one participating hotel or resort
50 . . . Displaying an indicia of participation in the rescue/travel assistance coverage program
52 . . . Collecting the data about the guest registered with the at least one participating hotel or resort
54 . . . Transmitting the data to the rescue entity by computer and internet
60 . . . Flow chart of a procedure for collecting and transmitting the data by computer and the internet.
62 . . . Completing a data layout format and an enrollment list by the at least one participating hotel or resort
64 . . . Submitting the data layout format and an enrollment list to rescue entity's FTP environment
66 . . . Uploading the data layout format and an enrollment list to dedicated Sequel server

### DETAILED DESCRIPTION

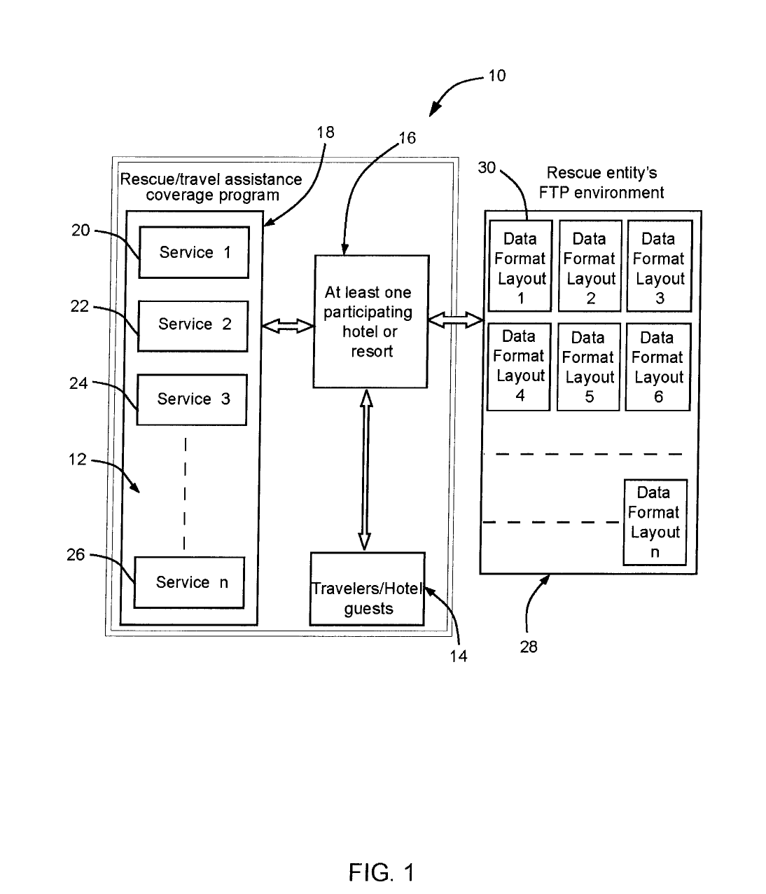

Referring to the drawings, a preferred embodiment illustrates a method for providing at least one emergency service 12 automatically to travelers/hotel guests 14 on both a nationwide and worldwide basis upon checking into a plurality of participating hotels and resorts 16 and generally indicated in FIGS. 1 through 3. Referring to FIG. 1, the major components that facilitate the method for providing a rescue/travel assistance coverage program 18 offering at least one emergency service 12 to the travelers/hotel guests 14 are shown in a diagrammatic illustration 10. The at least one emergency service can be labeled as service 1, service 2, service 3, . . . service n which are indicated as 20, 22, 24, 26 . . . respectively in FIG. 1. The at least one emergency service 12 may include emergency transportation services, medical evacuation/repatriation assistance services, legal assistance, emergency payment assistance, emergency message assistance, emergency cash assistance, vehicle return services, etc.

The emergency transportation services may include emergency evacuation, medically necessary repatriation, repatriation of mortal remains, visit by family member or friend, traveling companion transportation, return of dependent children and vehicle return. The medical assistance services include medical referrals, medical monitoring, emergency medical payments, hotel convalescence arrangements and medical insurance assistance. The legal assistance includes locating legal services and bail bond services.

The at least one participating hotel or resort 16 is offered with a rescue/travel assistance coverage program 18 by a business entity (“rescue entity”). The at least one participating hotel or resort 16 can offer the rescue/travel assistance coverage program 18 as a part of their services to the travelers/hotel guests 14. The rescue entity and a description of at least one emergency service 12 are listed on a plaque which may be exhibited in a reception area of the at least one participating hotel or resort 16. The at least one participating hotel or resort 16 provide the rescue/travel assistance coverage program 18 without separately charging the travelers/hotel guests 14 additional fees. The at least one participating hotel or resort 16 incorporates the costs of the rescue/travel assistance coverage program 18 into the cost of booking a room. Thereafter training is provided to hotel administration personnel explaining the services, the benefits available, the claims process and implementation requirements.

The at least one participating hotel or resort 16 is provided with at least one data layout format 30 which pertains to data that is to be sent to the rescue entity's file transfer protocol (FTP) environment 28 on a daily basis. The at least one data layout format 30 is filled with information about the guests 14 registered at the at least one participating hotel or resort 16 along with an enrollment list of all travelers/hotel guests 14 entitled to the rescue/travel assistance coverage program 18. When the at least one data layout format 30 with the recorded information is submitted to the rescue entity's FTP environment 28, the data is uploaded into a dedicated Sequel server which identifies all the travelers/hotel guests 14 that are covered on any given day so that enrollment can be verified in the event of a claim. In the event of a claim where, for example, any emergency medical services is required, the hotel, claimant, or intervening doctor may contact a resort rescue desk which is open 24/7 and speak to a resident doctor to assess the situation and whether or not any services offered by rescue entity are necessary. The at least one emergency service 12 is provided to travelers/hotel guests 14 enrolled in the event of a claim and their eligible dependents under the rescue/travel assistance coverage program. When the travelers/hotel guests 14 require any other additional services, e.g., legal and bond services, arrangements are made to accommodate the travelers/hotel guests 14 based on the situation.

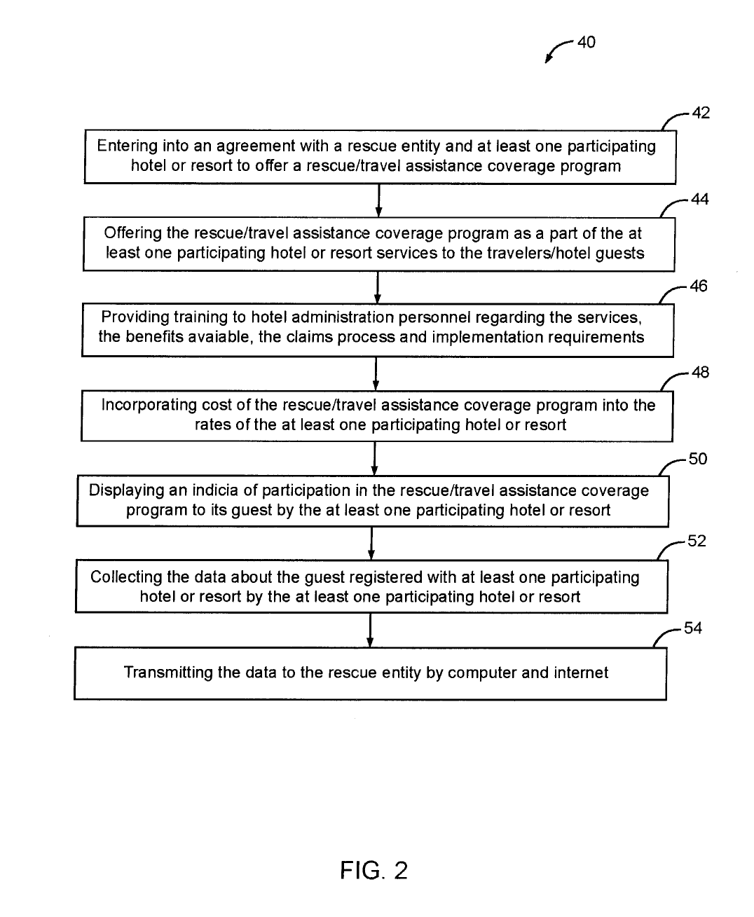

FIG. 2 is a flow chart 40 illustrating an operational procedure for providing the rescue/travel assistance coverage program 18 offering at least one emergency service 12 to the travelers/hotel guests 14. Initially, a rescue entity enters into an agreement with at least one participating hotel or resort to offer a rescue/travel assistance coverage program as indicated at block 42. The rescue/travel assistance coverage program is comprised of at least one emergency service for guests of the at least one participating hotel or resort. The at least one participating hotel or resort offers the rescue/travel assistance coverage program as a part of their services to the guests as indicated at block 44. Training is provided to hotel administration personnel explaining the rescue/travel assistance coverage program services, the benefits available, the claims process and implementation requirements as indicated at block 46. The at least one participating hotel or resort 16 incorporates the costs of the rescue/travel assistance coverage program 18 into the cost of booking a room and not paid separately by guests as indicated at block 48. The rescue entity and the description of the at least one emergency service are listed on a plaque which may be exhibited in a reception area of the at least one participating hotel or resort as indicated at block 50. Then, the data about the guest that registered with the at least one participating hotel or resort is collected as indicated at block 52 and the data is transmitted by computer and the internet to the rescue entity for inclusion in the rescue/travel assistance coverage program as indicated at block 54.

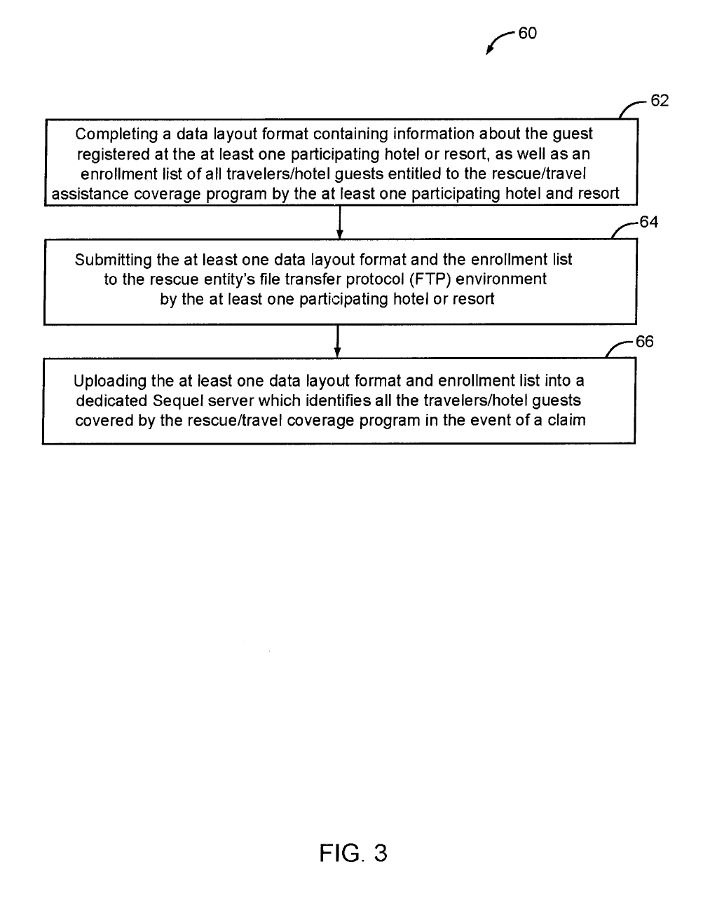

FIG. 3 is a flow chart 60 illustrating a procedure for collecting and transmitting the data by computer and the Internet. The at least one participating hotel or resort is provided with at least one data layout format pertaining to data that is to be sent to the rescue entity's FTP environment on a daily basis. The at least one data layout format is completed with information about the guests registered at the at least one participating hotel or resort, as well as an enrollment list of all travelers/hotel guests entitled to the rescue/travel assistance coverage program as indicated at block 62. The at least one data layout format and the enrollment list is submitted to the rescue entity's FTP environment as indicated at block 64. Finally, once the at least one data layout format with the recorded information is submitted to the rescue entity's FTP environment, the data is uploaded into a dedicated Sequel server which identifies all the travelers/hotel guests covered in the program in the event of a claim as indicated at block 66.

In the case of an emergency evacuation, or where a guest suffers an injury or sickness and adequate medical facilities are not available, the rescue entity arranges and provides emergency evacuation and adequate medical care. Services include arranging for transportation and related medically necessary services (including medical escort) in connection with the emergency evacuation. In the case of medically necessary repatriation, after initial treatment and stabilization of an injury or sickness, the rescue entity arranges and transports users back to their permanent place of residence for further medical treatment. Services include arranging for transportation and related medical services (including escort if necessary) and medical supplies necessarily incurred in connection with the repatriation.

In the case of repatriation of mortal remains (in the event of a death), the rescue entity renders assistance and provides for the return of mortal remains. Services include arranging for the location of a sending funeral home, transportation of the body from the site of death, to the sending funeral home, and to the airport, minimally necessary casket or air tray for transport, coordination of consular services (in case of death overseas), procuring death certificates, and transport of the remains from the airport to the receiving funeral home. Other services that might be performed in conjunction with those listed above include making travel arrangements for any traveling companions and identification and/or notification of next-of-kin.

Services also include a visit by a family member or friend if a guest is hospitalized for more than seven days and is traveling alone. The rescue entity arranges and provides the family member or friend with transportation to visit the guest. Visit by family member or friend services are subject to a maximum coverage limit, to include meals and accommodations.

In the case of traveling companion transportation, if a guest's traveling companion loses previously made travel arrangements due to a medical emergency, the rescue entity arranges and pays for the traveling companion's return home by the most direct and economical route.

In the event of an evacuation, medically necessary repatriation, or repatriation of mortal remains, the rescue entity returns a guest's non-commercial vehicle that is left behind unattended. A vehicle return service is provided in the event of an emergency evacuation wherein, medically necessary repatriation, or repatriation of mortal remains, is involved. The rescue entity arranges for the return of a guest's non-commercial vehicle that is left behind unattended.

Medical referrals consist of a service wherein, the rescue entity assists users in finding physicians, dentists and medical facilities. Medical monitoring consists of services wherein, during the course of a medical emergency, the rescue entity's professional case managers, including physicians and nurses, makes sure the appropriate level of care is maintained or determine if further intervention, medical transportation, or possibly repatriation (return to U.S.) is needed. The rescue entity provides case notification, both foreign and domestic, between the patient, family, physician, employer, travel company, and consulate as needed. The rescue entity continues to provide all necessary international claim coordination, to include hospital bill translation and interpretation, as needed.

Services include emergency medical payment services in which, when it is necessary for guests to obtain needed medical services, the rescue entity advances, in local currency, up to $10,000 to cover on-site medical expenses. The advance of funds is made to the medical provider after the rescue entity has secured funds from the guest's family.

Hotel convalescence arrangements comprise assistance with hotel arrangements if guests or their companions need to convalesce in a hotel prior to or following medical treatment.

Medical insurance assistance consists of coordinating notifications to medical insurers or managed care organizations, verifying policy enrollment, confirming medical benefits coverage, guaranteeing medical payments, assisting in the coordination of multiple insurance benefits, and handling claims paperwork flow.

Legal assistance comprises locating a legal service in which the rescue entity assists in contacting a local attorney or the appropriate consular officer if guests are arrested or detained, involved in an automobile accident, or otherwise need legal help. The rescue entity maintains communications with guests, their families, and employers until legal counsel has been retained by the guest. Legal assistance comprises bail bond services in which the rescue entity can assist in securing bail bond services in all available locations.

Emergency payment assistance consists of the rescue entity assisting guests in obtaining an advance of funds for medical expenses or other travel emergencies by coordinating directly with the guest's family, or a guest's credit card company, bank, employer, plan sponsor or other sources of credit. Emergency message assistance comprises services wherein the rescue entity records emergency messages from guests or emergency messages for guests for 24-hour periods. These messages may be retrieved at any time by guests, their family, or business associates. Emergency cash assistance comprises services where the rescue entity can assist guests with emergency cash up to $500. Arrangements are made through a friend, family member, business, or the guest's credit card company in the event of an emergency. All fees associated with the transfer or deliveries of funds are guest's responsibility.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for providing at least one emergency service automatically to hotel or resort guests on both a nationwide and worldwide basis upon checking into a participating hotel or resort, the method comprising the steps of:
entering into an agreement with a rescue entity and at least one participating hotel or resort to offer a rescue/travel assistance coverage program, comprising at least one emergency service, for guests of the at least one participating hotel or resort;
incorporating cost of the rescue/travel assistance coverage program into the rates of the at least one participating hotel or resort, and not paid for separately by guests;
displaying an indicia of participation in the rescue/travel assistance coverage program to its guest by the at least one participating hotel or resort, including a sign, plaque, or use of the rescue entity's logo on advertising; and
collecting the data about the guest registered with at least one participating hotel or resort by the at least one participating hotel or resort and transmitting the data to the rescue entity by computer and the internet for inclusion in the rescue/travel assistance coverage program.

2. The method of claim 1, wherein the at least one emergency service includes emergency transportation services, medical evacuation/repatriation assistance services, legal assistance, emergency payment assistance, emergency message assistance, emergency cash assistance, and vehicle return services.

3. The method of claim 1, wherein the data is collected and transmitted by computer and the internet in the following manner:
a. completing a data layout format containing information about the guest by the participating hotel or resort;
b. submitting the data layout format and an enrollment list to a rescue entity's file transfer protocol (FTP) environment by the participating hotel or resort; and
c. uploading the at least one data layout format and enrollment list into a dedicated Sequel server which identifies all travelers/hotel guests covered by the rescue/travel assistance coverage program in the event of a claim.

4. The method of claim 1, wherein the indicia of participation identifies the rescue entity and at least one emergency service provided.

5. The method of claim 3, wherein the at least one data layout format includes data that is sent to the rescue FTP environment on a daily basis.

6. The method of claim 1, wherein the at least one emergency service includes coverage for dependents of the guest.

7. The method of claim 1, wherein the at least one emergency service includes coverage for travel companions of the guest if the companion loses previously made travel arrangements due to a medical emergency, in which case the rescue entity arranges and pays for the traveling companion's return home.

8. The method of claim 2, wherein emergency transportation services includes the rescue entity arranging for transportation and related medically necessary services (including medical escort) in connection with the emergency evacuation, and in the case of medically necessary repatriation, after initial treatment and stabilization for an injury or sickness, the rescue entity arranges and transports guests back to their permanent place of residence for further medical treatment.

9. The method of claim 2, wherein the medical assistance services is provided when guests suffer an injury or sickness and adequate medical facilities are not available, in which case the rescue entity arranges for transportation and related medically necessary services, including medical escort, and medical supplies.

10. The method of claim 2, wherein the medical assistance includes return of mortal remains in which the rescue entity arranges for the location of a sending funeral home, transportation of the body from the site of death, to the sending funeral home, and to the airport, minimally necessary casket or air tray for transport, coordination of consular services (in case of death overseas), procuring death certificates, transport of the remains from the airport to the receiving funeral home, making travel arrangements for any traveling companions, and identification and/or notification of next-of-kin.

11. The method of claim 2, wherein the medical assistance includes a visit by a family member or friend if a guest is hospitalized for more than seven days and is traveling alone, in which case the rescue entity arranges and provides the family member or friend with transportation to visit the guest, subject to maximum coverage limits for meals and accommodations.

12. The method of claim 2, wherein the medical assistance includes medical referrals by the rescue entity in finding physicians, dentists and medical facilities, medical monitoring during the course of a medical emergency which includes providing case notification, both foreign and domestic, between the patient, family, physician, employer, travel company, and consulate as needed, and international claim coordination including hospital bill translation and interpretation.

13. The method of claim 2, wherein the medical assistance includes hotel convalescence arrangements comprising assistance with hotel arrangements if guests or their companions need to convalesce in a hotel prior to or following medical treatment.

14. The method of claim 2, wherein the medical assistance includes medical insurance assistance comprised of coordinating notifications to medical insurers or managed care organizations, verifying policy enrollment, confirming medical benefits coverage, guaranteeing medical payments, assisting in the coordination of multiple insurance benefits, and handling claims paperwork flow.

15. The method of claim 2, wherein the legal assistance, includes locating a legal service in which the rescue entity assists in contacting a local attorney or the appropriate consular officer if guests are arrested or detained, involved in an automobile accident, or otherwise need legal help, maintaining communications with guests, their families, and employers until legal counsel has been retained by the guest, and bail bond services in which the rescue entity can assist in securing bail bond services.

16. The method of claim 2, wherein the emergency payment assistance includes the rescue entity advancing local currency to cover on-site medical expenses when it is necessary for guests to obtain needed medical services, and after the rescue entity has secured funds from the guest's family, credit card company, bank, employer, plan sponsor or other sources of credit.

17. The method of claim 2, wherein the emergency message assistance comprises services wherein the rescue entity records emergency messages from guests or emergency messages for guests, and may be retrieved at any time by guests, their family, or business associates.

18. The method of claim 2, wherein the emergency cash assistance comprises services wherein the rescue entity assists guests with emergency cash after arrangements are made through a friend, family member, business, or the guests credit card company in the event of an emergency.

19. The method of claim 2, wherein the vehicle return services applies when medical repatriation or repatriation of mortal remains is necessary, or when there is an emergency evacuation, in which the rescue entity returns a guest's non-commercial vehicle that is left behind unattended.
